(19) United States
(12) Patent Application Publication
(10) Pub. No.: US 2007/0130079 A1
(43) Pub. Date: Jun. 7, 2007

(54) Enforcing subscription validity

(75) Inventors: Maxim A. Ivanov, Redmond, WA (US); Srikanth Shoroff, Sammamish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/480,770

(22) Filed: Jun. 30, 2006

Related U.S. Application Data
(60) Provisional application No. 60/739,396, filed on Nov. 23, 2005.

(51) Int. Cl. G06Q 99/00

(52) U.S. Cl. 705/59

(57) ABSTRACT

A system and method for management of software application use licenses and software application subscription licenses are provided. A software subscription service of one or more client computing devices having a number of subscriber-based software applications and a software subscriber agent. The software applications are associated with a software application use license and a software application subscription license. The system can also include a software subscription service for generating and transmitting software application subscription licenses to the client computing devices based upon a comparison of credentials. During the execution of the software application, the software subscription agent periodically transmits a request to update the software application subscription license based upon a detected condition.

### CROSS-REFERENCE TO RELATED APPLICATION

This application claims the benefit of U.S. Provisional Application No. 60/739,396, entitled ″Enforcing Subscription Validity on Software, and filed on Nov. 23, 2005. U.S. Provisional Application No. 60/739,396 is incorporated by reference herein.

### BACKGROUND

Generally described, a computing device, such as a personal computer, can include a wide variety of software applications for use by a user. In one common embodiment, new software applications loaded on a designated computing device such as by purchasing a copy of the software application or downloading the copy over a communication network, such as the Internet. Because of the nature of computer software and the nature of the mechanisms for installing new software (e.g., computer disks, CDs, DVDs, etc.), however, a single legitimate copy of a software application could be loaded on multiple computer devices against the intent of the software application manufacturer.

One attempt to mitigate the proliferation of unauthorized copies of a software application to multiple computing devices relates to the incorporation of a software application use license with the software application. Generally described, software application use licenses relates to a set of information utilized by the software application and/or a software application service to control the number of copies of a software application that can be loaded onto a computing device. The set of information can correspond to a unique product identifier, information related to machine characteristics of the computing devices (e.g., a data “snapshot” of the hardware configurations of the client computing device), and expiration data for the software application use license. Typically, the software application requires the present of the software application use license upon installation of the software application.

In practice, the unique product identifier may be located on documentation provided with the software application (e.g., on the cover of a CD case). A user may be required to manually enter the product identifier on the client computing device, which then transmits the product identifier along with the machine characteristics of the client computing device to the software application service as an “activation” request. The software application service then returns information that will enable the software application to execute on the particular client computing device. Thereafter, however, if the software application service receives a second activation request corresponding to the same product identifier but different machine characteristics, it assumes that the second activation request is fraudulent and the activation request can be denied. After a certain period of time after installation and/or use, the software application can cease to operate or operate in a reduced functionality mode until the software application has been successfully activated.

Software applications can become obsolete by newer or updated versions of the same software application. Likewise, users can have only an occasional need for a specific software application and may not be readily inclined to purchase the infrequently used software application. Accordingly, software application subscription services can provide access to newer and/or updated versions of software applications based upon the needs/demands of the user. The subscriptions can be based on a specific amount of time the particular software application is used (e.g., 40 hours of use) or based on date-based criteria (e.g., monthly, quarterly, yearly subscriptions).

Although software application use licenses can include expiration information upon which the software application use license is no longer valid, software application use license may not be well-suited for implementation in subscription-based software application. Typically, upon the expiration of the software application use license, a user must request a new software application use license. As described above, the user would be required to manually enter a new product identifier, which would be transmitted in a “renewal” request to the software service in a manner similar to the activation request. Depending on the frequency of the subscription (e.g., monthly), the manual reentry of new product identifiers may be burdensome. Additionally, typical software application use licenses may not be well suited for utilization in a subscription service corresponding to a grouping of a number of computing devices.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with an aspect, a system for facilitating a software subscription service is provided. The system includes one or more client computing devices that can include any number of subscription-based software applications. The software applications are associated with a software application use license and a software application subscription license. The client computing device can also include a software subscription agent that manages the software application subscription license. The system can also include a software subscription service for generating and transmitting software application subscription licenses to the client computing devices based upon a comparison of credentials. During the execution of the software application, the software subscription agent periodically transmits a request to update the software application subscription license based upon a detected condition, such as the upcoming expiration of the software application subscription license.

In accordance with another aspect, a method for managing a software application subscription is provided. The method may be implemented by a software subscription agent in a computer system including a number of subscription-based software applications associated with a software application use license and a software application subscription license. In accordance with the method, the software subscription agent obtains a set of current software application subscription licenses for the number of software applications and determines whether update criteria for the current software application subscription licenses have been satisfied. If so, the software subscription agent requests an updated software application subscription license from a software application subscription service upon detection of update criteria. The software application use license does not need to be updated and is independent of the software application subscription license.

In accordance with a further aspect, a computer-readable medium having computer-executable components associated with a software application on a client computing device is provided. The computer-executable components include a software application use component associated with the software application. The software application use component includes a unique product identification and information corresponding to machine characteristics of the client computing device. The software application use component can also include an indicator that a software application subscription license is required. The computer-executable components also include a software application subscription component associated with the software application. The software application subscription component includes a unique product identification and expiration criteria. Both the software application use component and the software application subscription component are required for execution of the software application on the client computing device.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a system for managing software application use licenses and software application subscription licenses for subscription-based software applications;

FIG. 2A is a block diagram of the system of FIG. 1 illustrating the provisioning of a software application use license;

FIG. 2B is a block diagram of the system of FIG. 1 illustrating the provisioning of a software application subscription license;

FIG. 2C is a block diagram of the system of FIG. 1 illustrating the updating of a software application subscription license;

FIG. 3A is a block diagram illustrative of information associated with a software application use license;

FIG. 3B is a block diagram illustrative of information associated with a software application subscription license;

FIG. 4 is a flow diagram illustrative of a software application subscription license generation routine implemented by a software subscription agent on a client computing device;

FIG. 5 is a flow diagram illustrative of a software application subscription license update routine implemented by a software subscription agent on a client computing device; and

FIG. 6 is a flow diagram illustrative of a software application subscription license update request processing routine implemented by a software application subscription service.

### DETAILED DESCRIPTION

Generally described, the present invention relates to a system, method, and computer-readable components for managing software application subscription licenses. More specifically, the present invention relates to a system, method, and computer-readable components for managing software application subscription licenses having expiration criteria in conjunction with software application use licenses. Although the present invention will be described with regard to illustrative operating environments, data structures, software components, and software routines, one skilled in the relevant art will appreciate that the disclosed embodiments are illustrative in nature and should not be construed as limiting.

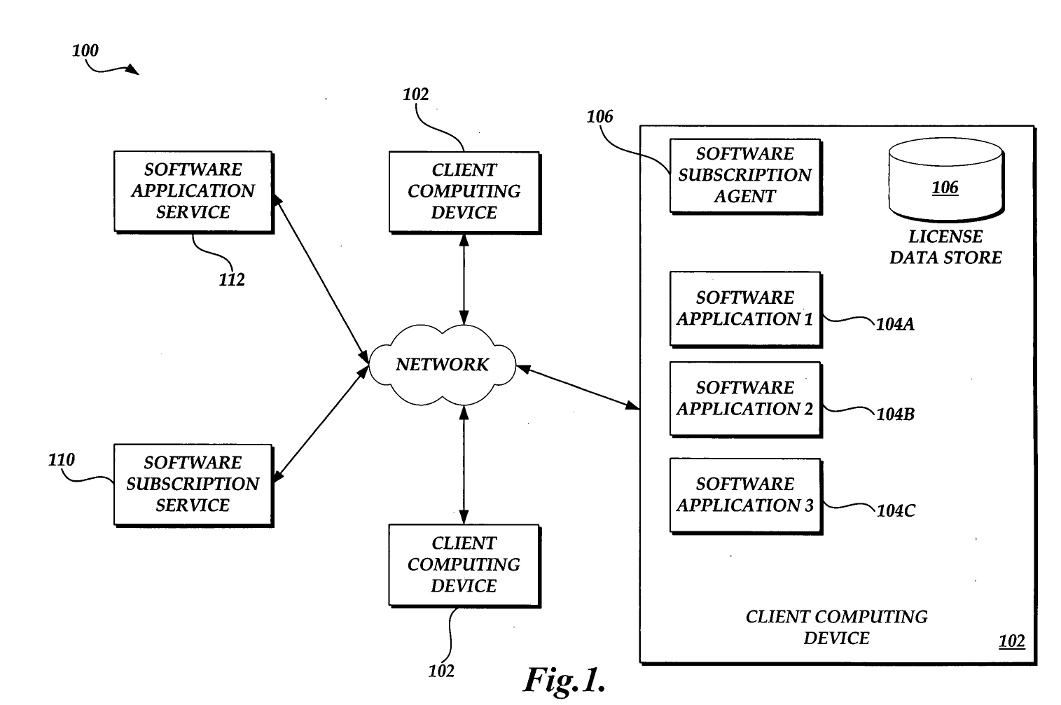

FIG. 1 is a block diagram of a system 100 for managing software application use licenses and software application subscription licenses for subscription-based software applications. The system 100 includes a number of client computing devices 102 that includes one or more software applications, such as software applications 104A, 104B, and 104C, that correspond to subscription-based software applications. One skilled in the relevant art will appreciate that a subscription-based software application can correspond to a software application whose execution on the client computing device 102 is controlled by a metric. Examples of metrics, include total time of execution on the client computing device, dates of availability to the client computing devices, an amount of data generated, an amount of data processed, and the like.

As will be described in greater detail below, in an illustrative embodiment, the execution of the software applications 104A-104C will be controlled through the utilization of software application use licenses and software application subscription licenses. The client computing device 102 can also include a software subscription agent 106 for managing the generation and updating of software application subscription licenses. Although not shown, the client computing device 102 can also include various components for generating and managing software application use licenses. The software application use licenses and software application subscription licenses may be stored in the license data store 106.

In an illustrative embodiment, a software application use license may apply to one or more software applications. In one aspect, a single software application use license may apply to multiple software applications on a single client computing device 102. In another aspect, a single software application use license may apply to the same type of software application (e.g., a word processing software application) on different, associated client computing devices (e.g., all client computing devices on a private network). In a similar manner, in an illustrative embodiment, a software application subscription license may apply to one or more software applications based on a set of credentials. In one aspect, a single software application subscription license may apply to multiple software applications on a single client computing device 102 based upon a single set of credentials (e.g., a single user). In another aspect, a single software application subscription license may apply to the same type of software application (e.g., a word processing software application) on different, associated client computing devices based on a shared set of credentials (e.g., all client computing devices on a private network).

With continued reference to FIG. 1, the system 100 can further include a software application service 112 for generating software application use licenses and a software subscription service 114 for generating and managing software application subscription licenses. In an illustrative embodiment, the software application service 112 and a software subscription service 114 can communicate with the various client computing devices 102 via a communication network, such as the Internet. One skilled in the relevant art will appreciate that the client computing devices and computing devices associated with the software application service 112 and a software subscription service 114 can correspond to a number of computing devices such as personal computers, server computers, hand-held computers, mobile telephones, embedded computing devices, and the like. Although the software application service 112 and a software subscription service 114 are illustrated as a single component, one skilled in the art will appreciate that the services can include a number of networked computing devices for providing the functions associated with the illustrated services.

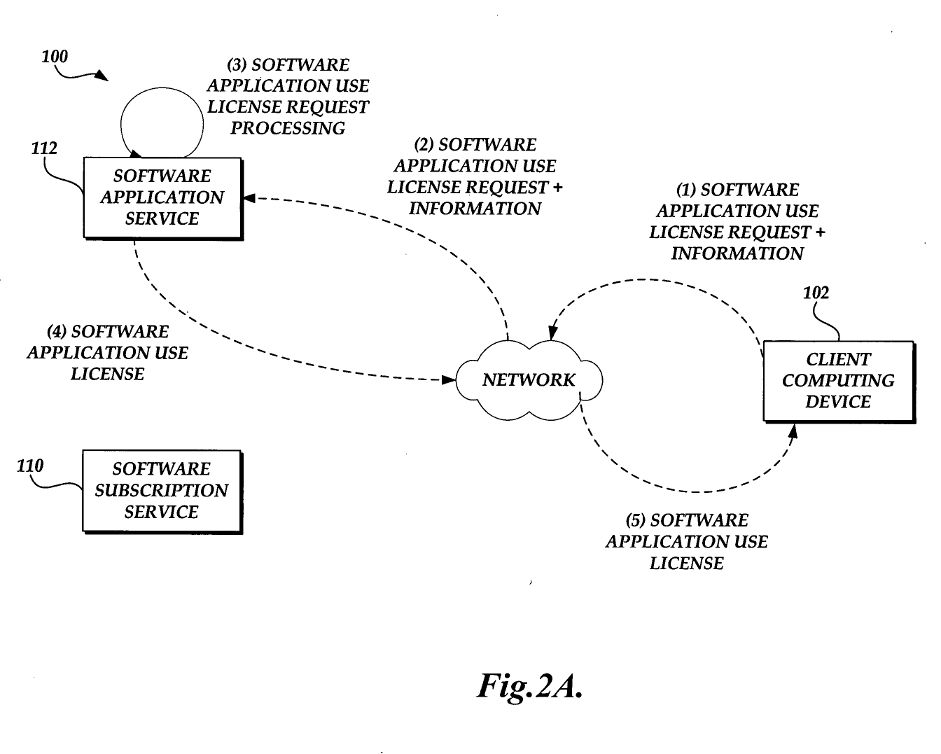

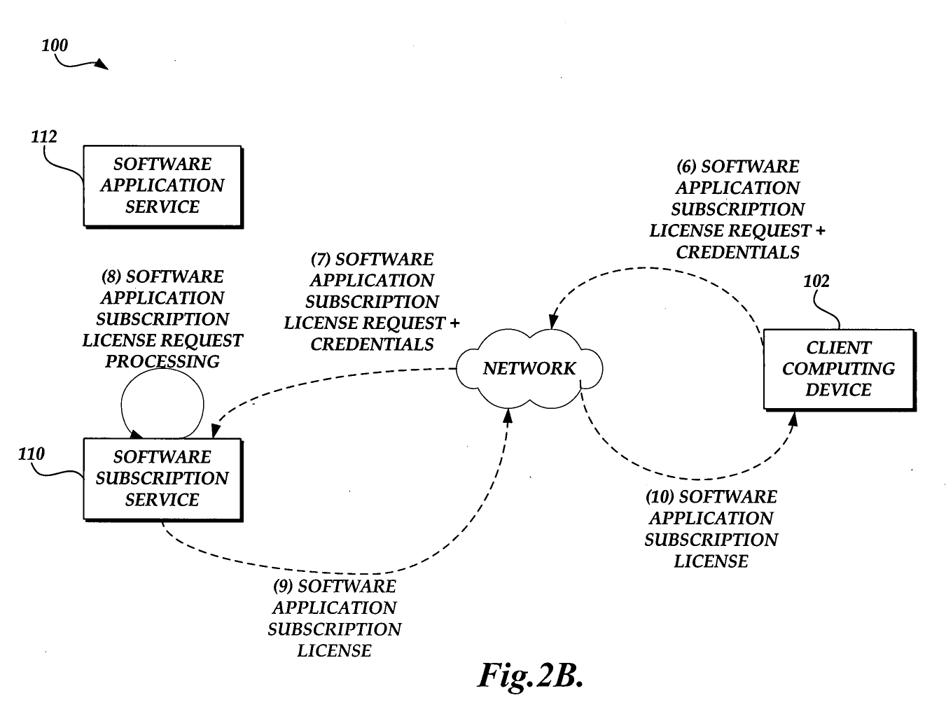

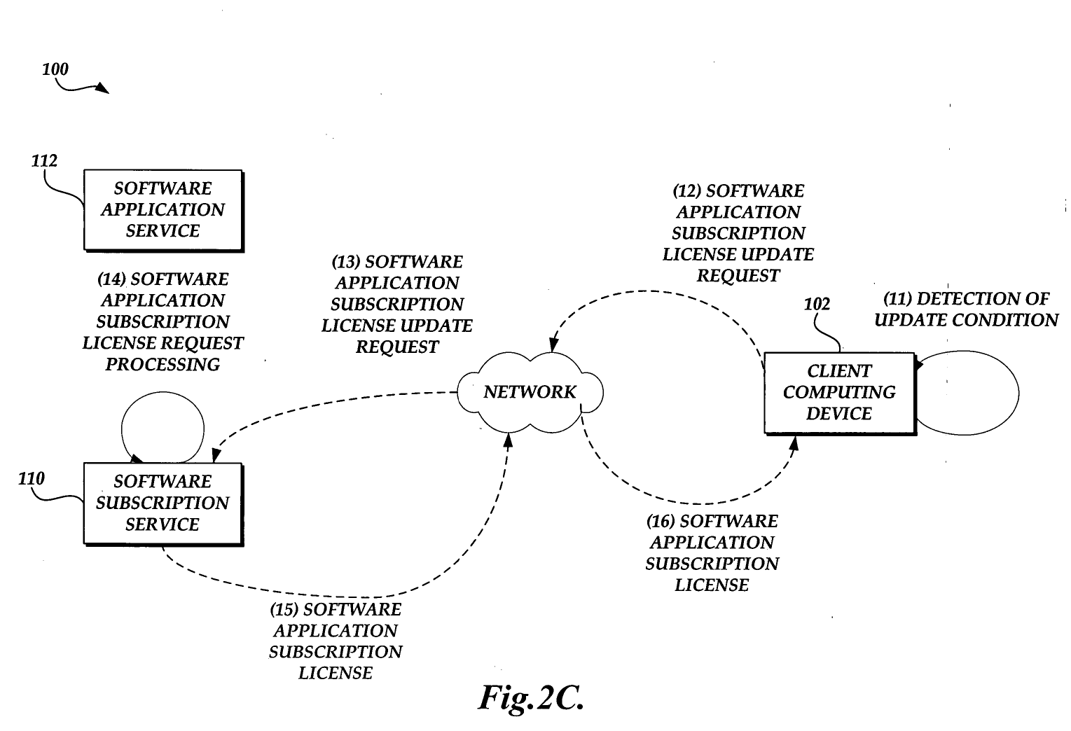

With reference now to FIGS. 2A-2C, an illustrative interaction between a client computing device 102 and the software application service 112 and a software subscription service 114 will be described. With reference to FIG. 2A, at some point after the installation of a software application (such as by downloading from a removable media or network connection) or otherwise initiation of a software application, the client computing device 102 transmits a software application use license request and associated information to the software application service 112. The software application use license request can be accompanied by a unique product id, such as a 32-bit unique number, and one or more pieces of data characteristic of the hardware components and/or hardware/software configurations of the particular client computing device 102. The software application service 112 processes the request with the corresponding information and determines whether a software application use license should be granted. For example, the software application service 112 can determine whether the unique product id is valid, uncompromised, and/or unexpired. Additionally, the software application service 112 can determine whether the unique product id has been previously associated with different machine characteristics. If a license should be granted, the software application service 112 generates a software application use license and transmits the software application use license to the client computing device 102.

With reference now to FIG. 2B, the client computing device 102 also transmits a software application subscription license request and associated credentials to the software subscription service 114. For example, the software application use license may include an indicator that a corresponding software application subscription license may be required to utilize the particular software application. As previously described, the credentials may correspond to a single user credential or to group credentials associated with a group of users. The software subscription service 114 processes the request with the corresponding information and determines whether a software application subscription license should be granted. The processing of the software application subscription license request will be described in greater detail below. If a subscription license should be granted, the software subscription service 114 generates a software application subscription license and transmits the software application subscription license to the client computing device 102.

Turning now to FIG. 2C, upon receipt of the software application use license and software application subscription license, the software subscription agent 106 manages the need to update the software application subscription license upon detection of an update condition. For example, the update condition can correspond to a combination of a detection of a network connection capable for establishing communication with the software subscription service 114 and the determination that the expiration of the software application subscription license is within a threshold amount of time (e.g., within one month). If an update condition is detected, the client computing device 102 also transmits a software application subscription license update request and associated credentials to the software subscription service 114. Again, the software subscription service 114 processes the update request with the corresponding information and determines whether a software application subscription license should be granted or otherwise be updated. If a subscription license should be granted, the software subscription service 114 generates a software application subscription license and transmits the software application subscription license to the client computing device 102.

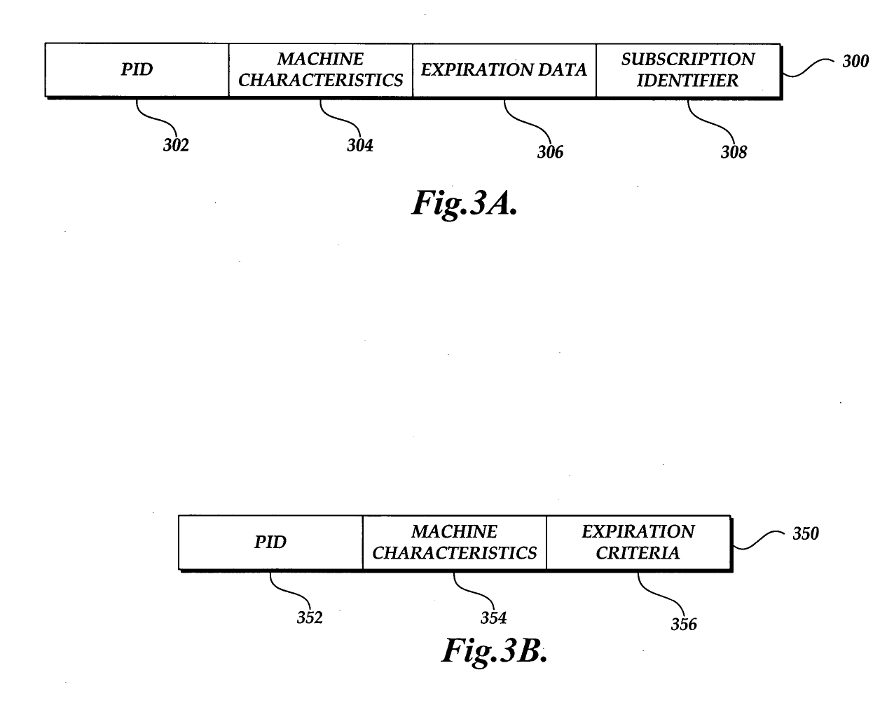

With reference now to FIGS. 3A and 3B, illustrative components for the software application use license (FIG. 3A) and the software application subscription license (FIG. 3B) will be described. With reference to FIG. 3A, a software application use license 300 can include various components utilized by the software application service 112 and/or the client computing device 102. Specifically, the software application use license 300 includes a unique product id component 302 that is associated with one or more authorized instances of a software application 104. The software application use license 300 can also include a machine characteristics component 304 that is associated with various machine characteristics of the particular client computing device 102. The software application use license 300 can further include expiration data that defines when the software application use license 300 will no longer be valid. In an illustrative embodiment, upon the expiration of the software application use license 300, the software application cannot update the license, but must generate a new software application use license 300. The software application use license 300 can still further include a subscription identifier component 308 for identifying that the software application use license 300 requires a software application subscription license. One skilled in the relevant art will appreciate that alternative, additional or less data may be associated with the software application use license 300.

With reference now to FIG. 3B, a software application subscription license 350 can include various components utilized by the software subscription service 114 and/or the client computing device 102. Specifically, the software application subscription license 350 includes a unique product id component 352 that is associated with one or more authorized instances of a software application 104. In an illustrative embodiment, unique product id components 302 and 352 may share the same unique product id. The software application subscription license 350 can also include a machine characteristics component 354 that is associated with various machine characteristics of the particular client computing device 102. In an illustrative embodiment, machine characteristics components 304 and 354 may share the same machine characteristics or different machine characteristics. Additionally, the machine characteristics component 354 may be omitted, or otherwise not utilized. The software application subscription license 350 can further include expiration criteria that define when the software application subscription license 300 will no longer be valid and requires updating. Upon the expiration of the software application subscription license, the software application may enter into a reduced functionality mode and/or cease to operate altogether. For example, one or more features of the software application 104 may no longer be available. Alternatively, the software application 104 may begin prompting the user to update a subscription service account. One skilled in the relevant art will appreciate that alternative, additional or less data may be associated with the software application subscription license 350.

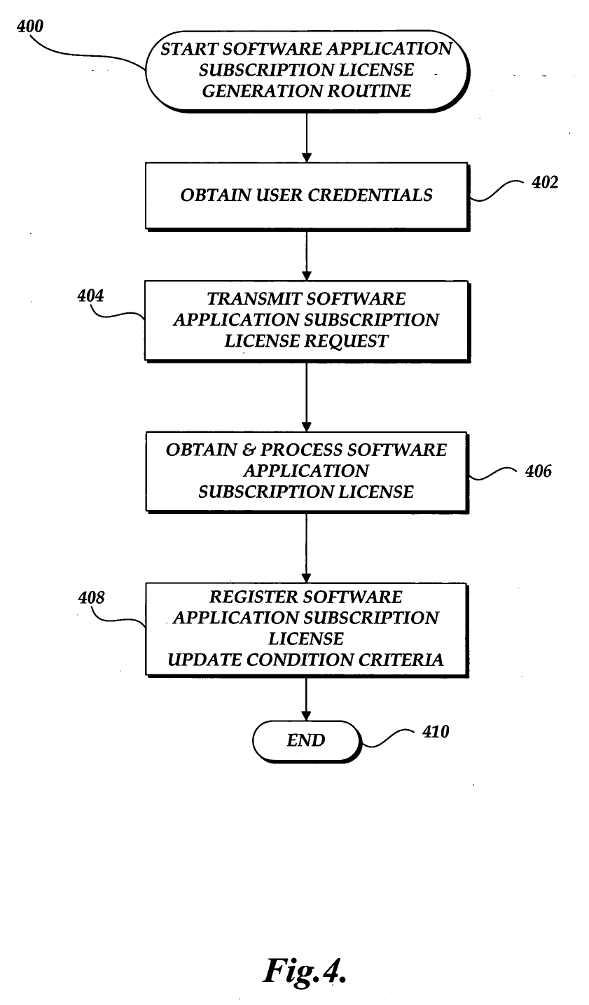

Turning now to FIG. 4, a flow diagram illustrative of a software application subscription license generation routine 400 implemented by a software subscription agent 106 on a client computing device will be described. At block 402, the client computing device 102 obtains credentials corresponding to a software application subscription account. The credentials may correspond to general purpose credentials utilized by a single user or group of users for multiple purposes. Alternatively, the credentials may correspond to specific purpose credentials utilized by a single user or group of users solely for the software application subscription service. At block 404, the client computing device 102 transmits a software application subscription license request to the software subscription service 114. In an illustrative embodiment, the client computing device 102 may automatically transmit the request, upon review of the software application use license and/or upon a request by a component such as the software application 104.

Thereafter, at block 406, the client computing device obtains and processes the software application subscription license. In one aspect, the client computing device 102 can display a unique product id for use by the user upon prompting by the software application 104. In another aspect, the client computing device 102 can store the software application subscription license in the license data store 108. In a further aspect, the software application subscription license may be processed to identify the expiration criteria 356 (FIG. 3B). At block 408, update condition criteria corresponding to the software application 104 and/or the software application subscription license 350 are registered. For example, the software application 104 may specify that a software application subscription license should be updated upon detection of a network condition if the subscription license will expire in the next month. In another example, the software application 104 may specify that all subscription licenses be updated upon request of an administrator. At block 410, the routine 400 terminates.

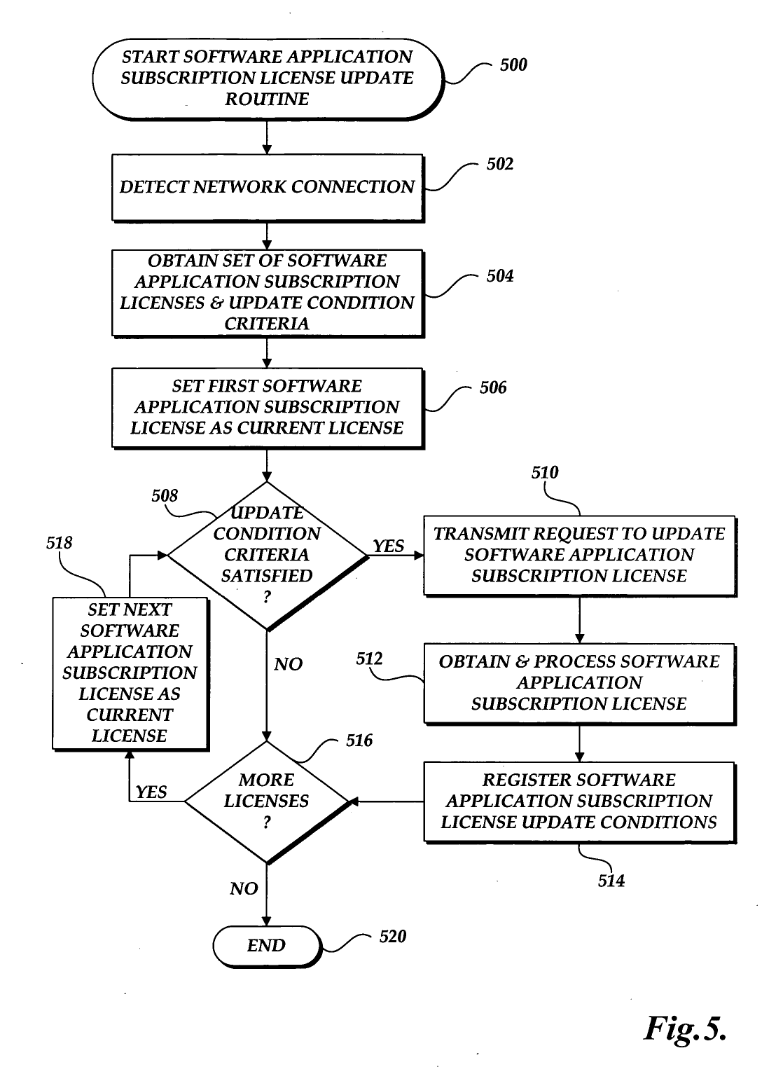

Referring now to FIG. 5, a flow diagram illustrative of a software application subscription license update routine 500 implemented by a software subscription agent 106 on a client computing device will be described. At block 502, the client computing device 102 detects a network connection. In an illustrative embodiment, the client computing device 102 may not have a persistent or reliable connection with a communication network (e.g., a dial-up network connection). Accordingly, the client computing device 102 may be configured to leverage any instances in which a network communication is available and corresponding software application subscription licenses may be updated. In the event that a persistent or reliable network connection is available, block 502 may be omitted. At block 504, the software subscription agent 106 obtains at least a subset of currently store software application subscription licenses. In an illustrative embodiment, a single software subscription agent 106 may manage software application subscription licenses for a variety of software applications 104. Alternatively, each software application 104 may utilize its own software subscription agent. In the event that update condition criteria associated with the software application subscription license is stored separately, the software subscription agent 106 would also obtain the update condition criteria.

At block 506, the software subscription agent 106 sets the first identifier software application subscription license as the current software application subscription license. At decision block 508, a test is conducted to determine whether the update condition associated with the current software application subscription license is satisfied. In an illustrative embodiment, the update condition criteria can correspond to the update conditions registered when the software application subscription license was received and processed. In another embodiment, additional update conditions may also be provided by the software application 104 and/or software subscription agent 106. Additionally, the update condition criteria may be in the form of a set of alternative conditions that satisfaction of which will result in the satisfaction of the update condition as a whole.

If the update condition has been satisfied, at block 510, the client computing device 102 transmits a software application subscription license update request to the software subscription service 114. Thereafter, at block 512, the client computing device obtains and processes the software application subscription license. In an illustrative embodiment, the client computing device 102 may process the software application subscription license in a manner similar to block 406 (FIG. 4). At block 514, update conditions corresponding to the software application 104 and/or the software application subscription license 350 are registered.

If the update condition has not been satisfied for the current license at decision block 508 or upon registration of the an updated software application subscription license at block 514, at decision block 516, a test is conducted to determine whether any additional software application subscription licenses remain from the subset of currently stored software application subscription licenses identified in block 504. If so, the next software application subscription license in the subset is set as the current license at block 518 and the routine 500 returns to decision block 508. Alternatively, the routine 500 terminates at block 520.

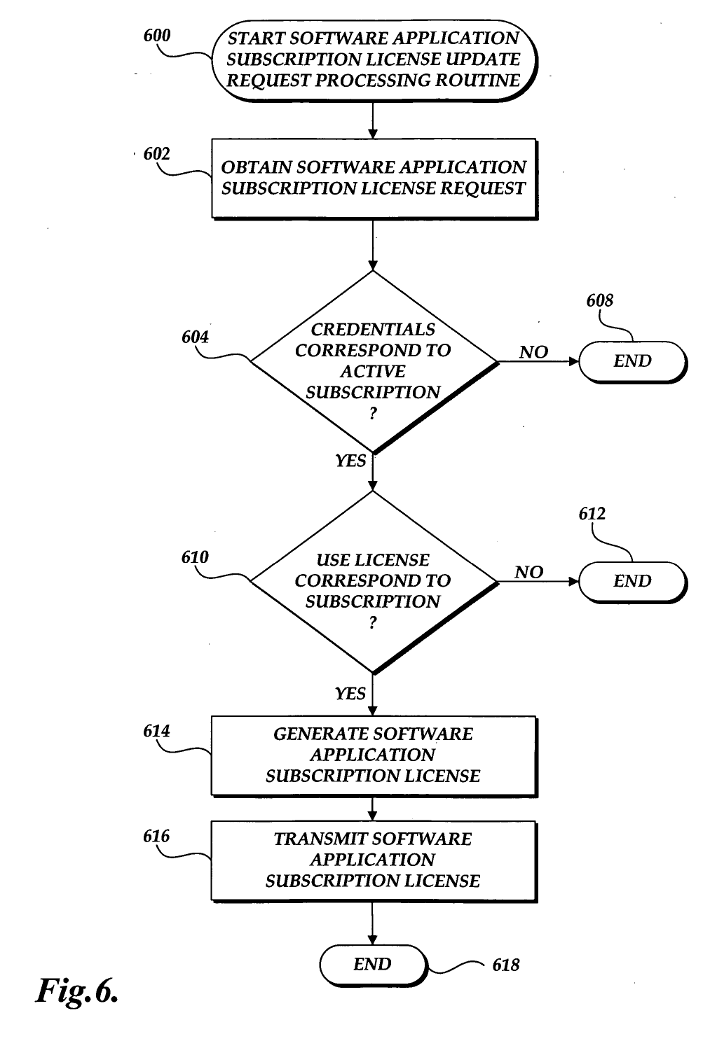

Referring now to FIG. 6, a flow diagram illustrative of a software application subscription license update request processing routine 600 implemented by a software application subscription service 1 14 will be described. At block 602, the software application subscription service 114 obtains a software application subscription license request from a client computer 102. In an illustrative embodiment, the request may correspond to a new software application subscription license. Alternatively, the request may correspond to an update of a pre-existing software application subscription license.

At decision block 604, a test is conducted to determine whether the credentials provided in the request correspond to an active subscription. If the credentials do not correspond to an active subscription, the routine 600 terminates at block 608. Alternatively, at decision block 610, a test is conducted to determine whether a software application use license associated with the software application corresponds to a subscription account. In an illustrative embodiment, if the software application use license does not specify that a software application subscription license is also required, the software subscription service 114 will not generate a subscription license. Accordingly, if the use license does not correspond to a subscription, the routine 600 terminates at block 612.

If the software application use license corresponds to a subscription, at block 614, the software subscription service 114 generates a software application subscription license 350 (FIG. 3). At block 616, the software subscription service 114 transmits the software application subscription license 350 to the client computing device 102. At block 618, the routine 600 terminates.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system for facilitating a software subscription service comprising:
one or more client computing devices including at least one software application and a software subscription agent, wherein the at least one software application is associated with a software application use license and a software application subscription license; and
a software subscription service for providing software application subscription licenses;
wherein the software subscription agent transmits a request to update the software application subscription license based upon a detected condition.

2. The system as recited in claim 1 further comprising a software application license service for providing the software application use license to the client computing device.

3. The system as recited in claim 2, wherein the software application license service provides the software application use license during an activation of the software application on the client computing device.

4. The system as recited in claim 1, wherein the software subscription license is associated with an expiration date, and wherein software subscription agent transmits the request to update the software application subscription license upon detection of a time window related to the expiration date.

5. The system as recited in claim 4, wherein the software subscription agent is further operable to request that the software application enter into a reduced functionality mode after a time period after the expiration of the software application subscription license.

6. The system as recited in claim 4, wherein the software subscription agent is further operable to request that the software application cease to operate after a time period after the expiration of the software subscription license.

7. The system as recited in claim 1, wherein the software application use license includes at least one identifier indicating that an unexpired software application subscription license is required.

8. The system as recited in claim 1, wherein at least one client computing device includes two or more software applications, wherein each software application is associated with a software application use license and a software application subscription license, and wherein the software subscription service provides software application subscription licenses for each of the two or more software applications.

9. The system as recited in claim 1 further comprising a plurality of client computing devices, wherein each client computing device including at least one software application and a software subscription agent and wherein the at least one software application is associated with a software application use license common to the plurality of client computing devices and a software application subscription license unique to each of the plurality of client computing devices.

10. The system as recited in claim 1, wherein the software subscription services generates new software application subscription licenses in response to the update request from the client computing device.

11. In a computer system including at least one software application, wherein the at least one software application is associated with a software application use license and a software application subscription license, a method for managing a software application subscription comprising:
obtaining a current software application subscription license;
determining whether update criteria for the current software application subscription license is detected; and
requesting an updated software application subscription license from a software application subscription service upon detection of update criteria.

12. The method as recited in claim 11, wherein the update criteria include an expiration date for the software application subscription license and wherein determining whether update criteria for the current software application subscription license is detected includes determining whether a current date is within a threshold of the expiration date.

13. The method as recited in claim 12, wherein the threshold is one month.

14. The method as recited in claim 11, wherein the update criteria include an availability of a communication network connection.

15. The method as recited in claim 11, wherein the software subscription license is associated with an expiration date, the method further comprising requesting that the software application cease to operate after a time period after an expiration of the software subscription license.

16. The method as recited in claim 11, wherein the software subscription license is associated with an expiration date, the method further comprising requesting that the software application that the software application enter into a reduced functionality mode after a time period after the expiration of the software application subscription license.

17. A computer-readable medium having computer-executable components associated with a software application on a client computing device, the computer-executable components comprising:
a software application use component associated with the software application and including a unique product identification and information corresponding to machine characteristics of the client computing device; and
a software application subscription component associated with the software application and including a unique product identification and expiration criteria;
wherein the software application use component and the software application subscription component are required for execution of the software application on the client computing device.

18. The computer-executable components as recited in claim 17, wherein the software application use component includes an identifier utilized by the client computing device to manage the software application subscription component.

19. The computer-executable components as recited in claim 17, wherein the software application subscription component includes information corresponding to machine characteristics of the client computing device.

20. The computer-executable components as recited in claim 17, wherein the expiration criteria include date information.
